(19) United States
(12) Patent Application Publication
(10) Pub. No.: US 2022/0041156 A1
(43) Pub. Date: Feb. 10, 2022

(54) CONTROL SYSTEM FOR HYBRID VEHICLE

(71) Applicant: TOYOTA JIDOSHA KABUSHIKI KAISHA, Toyota-shi (JP)

(72) Inventor: Tatsuya IMAMURA, Okazaki-shi (JP)

(73) Assignee: TOYOTA JIDOSHA KABUSHIKI KAISHA, Toyota-shi (JP)

(21) Appl. No.: 17/371,689

(22) Filed: Jul. 9, 2021

(30) Foreign Application Priority Data
Aug. 7, 2020 (JP) 2020-134664

(51) Int. Cl. B60W 20/20; B60K 6/26; B60K 6/36; B60K 6/387

(52) U.S. Cl. CPC B60W 20/20; B60K 6/26; B60K 6/36; B60K 6/387; B60W 2710/242; B60W 2710/08; B60W 2510/0638; B60W 2552/15; B60W 2555/40; B60W 2530/10; B60W 2510/244; B60W 2510/0657; B60W 2530/203

(57) ABSTRACT

A control system for a hybrid vehicle configured to avoid a sudden and significant reduction in a drive torque generated by a motor during high load operation. A controller comprises a determiner that determines a satisfaction of a predetermined condition, and a power limiter that restricts an upper limit of an output power of an electric storage device supplied to the motor upon satisfaction of the predetermined condition, to a restricted upper limit value which is smaller than a normal upper limit value set in a case that the predetermined condition is not satisfied.

### CROSS-REFERENCE TO RELATED APPLICATIONS

The present disclosure claims the benefit of Japanese Patent Application No. 2020-134664 filed on Aug. 7, 2020 with the Japanese Patent Office, the disclosures of which are incorporated herein by reference in its entirety.

### BACKGROUND

### Field of the Disclosure

Embodiments of the present disclosure relate to the art of a control system for a hybrid vehicle in which a prime mover includes an engine and a motor, and more especially, to a control system for controlling an output torque of the motor under high load operation.

### Discussion of the Related Art

JP-B2-4075959 describes a control system for a hybrid vehicle having an engine and a motor as a prime mover. The control system taught by JP-B2-4075959 is configured to operate the engine in the lean-burn mode in which an air/fuel ratio is higher than that in the stoichiometric mode. However, although a fuel consumption may be reduced, a torque generated by the engine will be insufficient in the lean-burn mode. According to the teachings of JP-B2-4075959, therefore, the motor is operated in the lean-burn mode to generate an assist torque to assist the torque generated by the engine. The control system taught by JP-B2-4075959 is further configured to increase an opening degree of a throttle valve of the engine with respect to a position of an accelerator pedal, when a state of charge level of a battery supplying electricity to the motor falls to a predetermined level or lower and hence the motor cannot generate the assist torque.

JP-A-2005-160252 describes a control system for a hybrid vehicle that is configured to assist a drive torque propelling the hybrid vehicle by a motor to maintain a vehicle speed when an accelerator pedal is returned. According to the teachings of JP-A-2005-160252, an amount of an assist torque generated by the motor is determined in accordance with a state of charge level of a battery.

JP-A-2004-032904 describes a control device of hybrid vehicle that is configured to increase a ratio of an output torque of a motor to an output torque of an engine for the purpose of reducing noise generated by the engine.

A drive torque may be increased without increasing fuel consumption and the engine noise may be reduced, by generating an assist torque by the motor in addition to the drive torque of the engine as taught by the above-explained prior art documents. However, if the state of charge level of the battery falls to a lower limit level as a result of supplying electricity to the motor from the battery, the electricity can no longer be supplied from the battery to the motor and the motor will stop suddenly. For instance, when the vehicle climbs an hill while depressing an accelerator pedal deeply or travels while towing a mobile home, an electric consumption to generate the assist torque by the motor is increased significantly and the state of charge level of the battery will fall to the lower limit level promptly. As a result, the motor may stop suddenly and the drive torque to propel the vehicle may drop significantly. That is, the drive torque to propel the vehicle will drop undesirably irrespective of an operation carried out by the driver, and hence a speed of the vehicle may not be maintained to a desired speed.

### SUMMARY

Aspects of embodiments of the present disclosure have been conceived noting the foregoing technical problems, and it is therefore an object of the present disclosure to provide a control system for a hybrid vehicle configured to avoid a sudden and significant reduction in a drive torque generated by a motor during high load operation.

The control system according to the exemplary embodiment of the present disclosure is applied to a hybrid vehicle comprising: an engine that serves as a main prime mover to generate a drive torque to propel the hybrid vehicle; a motor that generates an assist torque added to the drive torque generated by the engine; and an electric storage device that supplies an electric power to the motor to generate the assist torque by the motor, when a required drive force to propel the hybrid vehicle is equal to or greater than a threshold force. The control system comprises a controller that controls an output torque of the motor. In order to achieve the above-explained objective, according to the exemplary embodiment of the present disclosure, the controller comprises: a determiner that is configured to determine a satisfaction of a predetermined condition; and a power limiter that is configured to restrict an upper limit of an output power of the electric storage device supplied to the motor upon satisfaction of the predetermined condition, to a restricted upper limit value that is smaller than a normal upper limit value set in a case that the predetermined condition is not satisfied.

In a non-limiting embodiment, the determiner may further be configured to predict a satisfaction of the predetermined condition, and the power limiter may further be configured to restrict the upper limit of the output power of the electric storage device to the restricted upper limit value when the determiner predicts a satisfaction of the predetermined condition.

In a non-limiting embodiment, the predetermined condition may include a fact that the required drive force to propel the hybrid vehicle at a predetermined speed is equal to or greater than a threshold value.

In a non-limiting embodiment, the predetermined condition may include at least one of: a fact that the hybrid vehicle tows an object; a fact that the hybrid vehicle continuously climbs a hill whose gradient is equal to or steeper than a threshold degree for a threshold distance or longer; a fact that an altitude above sea level of a road on which the hybrid vehicle travels is equal to or higher than a threshold level; and a fact that a total weight of freight on the hybrid vehicle is equal to or heavier than a threshold weight.

In a non-limiting embodiment, the upper limit of the output power of the electric storage device may be reduced with an increase in: the distance of the hill whose gradient is equal to the threshold degree or steeper; the altitude above sea level of the road; or the total weight of the freight on the hybrid vehicle.

In a non-limiting embodiment, the predetermined condition may include a condition that is changed in accordance with a state of charge level of the electric storage device.

In a non-limiting embodiment, the motor may include a first motor and a second motor. Furthermore, the hybrid vehicle may further comprise: a first differential mechanism that performs a differential action among a first rotary element that is connected to the engine, a second rotary element that is connected to the first motor, and a third rotary element; a second differential mechanism that performs a differential action among a fourth rotary element that is connected to the second motor and a pair of drive wheels, a fifth rotary element that is connected to the third rotary element, and a sixth rotary element; a first engagement device that selectively connects the first rotary element to the sixth rotary element; and a second engagement device that selectively connects any two of the fourth rotary element, the fifth rotary element, and the sixth rotary element. In addition, an operating mode of the hybrid vehicle may include: a first hybrid mode that is established by engaging the first engagement device while disengaging the second engagement device; and a second hybrid mode that is established by engaging the second engagement device while disengaging the first engagement device.

In a non-limiting embodiment, the controller may be further configured to select the operating mode in which a maximum output power of the engine is higher from the first hybrid mode and the second hybrid mode upon satisfaction of the predetermined condition.

In a non-limiting embodiment, the maximum output power of the engine may be governed by an upper limit torque of the engine and an upper limit speed of the engine governed by characteristics of constitutional members of the differential mechanisms.

In a non-limiting embodiment, the controller may be further configured to cancel the restriction on the upper limit of the output power of the electric storage device if the predetermined condition is no longer satisfied.

Thus, according to the exemplary embodiment of the present disclosure, the upper limit of the output power of the electric storage device is restricted under high load conditions compared to that under low load conditions. For example, the upper limit of the output power of the electric storage device is restricted when the hybrid vehicle tows an object such as a mobile home or when the hybrid vehicle travels on a road higher than the threshold level. According to the exemplary embodiment of the present disclosure, therefore, the electric storage device can be prevented from being out of charge so that the output power of the motor can be maintained even during high load operation. For this reason, it is possible to prevent sudden reduction in a speed of the hybrid vehicle and sudden drop in a drive force to propel the hybrid vehicle during high load operation. In addition, the driver can be prevented from being upset and disturbed by such sudden reduction in a speed of the hybrid vehicle and sudden drop in a drive force to propel the hybrid vehicle.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a skeleton diagram schematically showing one example of a hybrid vehicle to which the control system according to the embodiment of the present disclosure is applied;

FIG. 2 is a block diagram showing a structure of an electronic control unit;

FIG. 3 is a table showing engagement states of engagement devices and operating conditions of prime movers in each operating mode;

FIG. 4 is a nomographic diagram showing a situation in a HV-High mode;

FIG. 5 is a nomographic diagram showing a situation in a HV-Low mode;

FIG. 6 is a nomographic diagram showing a situation in a fixed mode;

FIG. 7 is a nomographic diagram showing a situation in an EV-Low mode;

FIG. 8 is a nomographic diagram showing a situation in an EV-High mode;

FIG. 9 is a nomographic diagram showing a situation in a single-motor mode;

FIG. 10 shows a map for determining an operating mode during propulsion in a CS mode;

FIG. 11 shows a map for determining an operating mode during propulsion in a CD mode;

FIG. 12 is a flowchart showing one example of a routine executed by the control system according to the embodiment of the present disclosure;

FIG. 13 is a map for determining an upper limit of an output power of a battery;

FIG. 14 is a time chart indicating a temporal change in the conditions of the hybrid vehicle during execution of the routine shown in FIG. 12;

FIG. 15 is a flowchart showing another example of the routine executed by the control system according to the embodiment of the present disclosure;

FIG. 16 is a map for determining a maximum output power of the engine in the HV-Low mode and the HV-High mode with respect to a speed of the hybrid vehicle;

FIG. 17 is a skeleton diagram schematically showing another example of the hybrid vehicle to which the control system according to embodiment of the present disclosure is applied; and

FIG. 18 is a time chart indicating temporal changes in the conditions of the hybrid vehicle according to a comparative example.

### DETAILED DESCRIPTION OF THE PREFERRED EMBODIMENT(S)

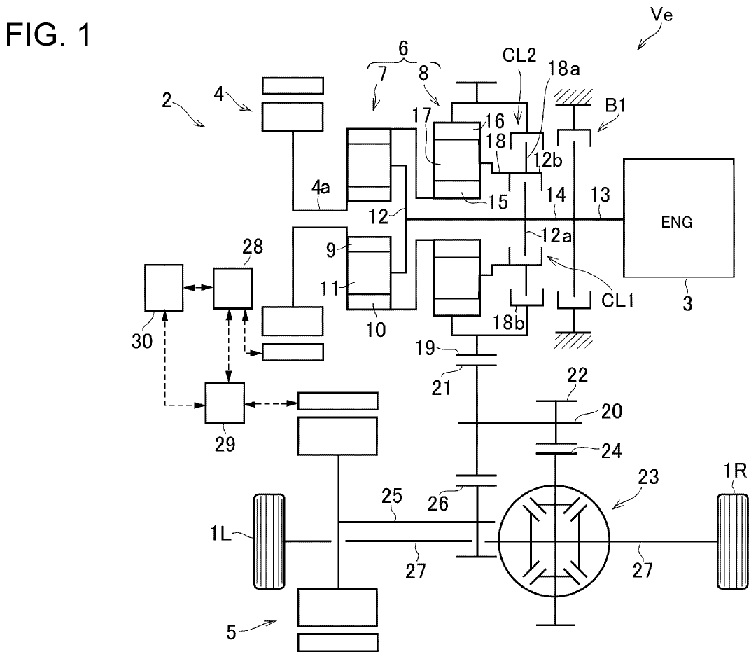

An exemplary embodiment of the present disclosure will now be explained with reference to the accompanying drawings. Referring now to FIG. 1, there is shown one example of a structure of a hybrid vehicle (as will be simply called the “vehicle” hereinafter) Ve to which the control system according to the exemplary embodiment of the present disclosure is applied. Specifically, FIG. 1 shows a drive unit 2 of the vehicle Ve that drives a pair of front wheels 1R and 1L, and the drive unit 2 comprises an engine (referred to as “ENG” in the drawings) 3 as a main prime mover, a first motor (referred to as “MG1” in the drawings) 4, and a second motor (referred to as “MG2” in the drawings) 5. According to the exemplary embodiment, a motor-generator having a generating function is adopted as the first motor 4. In the vehicle Ve, a speed of the engine 3 is controlled by the first motor 4, and the second motor 5 is driven by electric power generated by the first motor 4 to generate a drive force for propelling the vehicle Ve. Optionally, the motor-generator having a generating function may also be employed as the second motor 5.

A power split mechanism 6 as a differential mechanism is connected to the engine 3. The power split mechanism 6 includes a power split section 7 that distributes an output torque of the engine 3 to the first motor 4 side and to an output side, and a transmission section 8 that alters a torque split ratio.

In the vehicle Ve shown in FIG. 1, a single-pinion planetary gear unit that performs differential action among three rotary elements is adopted as the power split section 7. Accordingly, the power split section 7 serves as a first differential mechanism of the embodiment. Specifically, the power split section 7 comprises: a sun gear 9; a ring gear 10 as an internal gear arranged concentrically around the sun gear 9; a plurality of pinion gears 11 interposed between the sun gear 9 and the ring gear 10 while being meshed with both gears 9 and 10; and a carrier 12 supporting the pinion gears 11 in a rotatable manner. In the drive unit 2, accordingly, the carrier 12 serves as a first rotary element, the sun gear 9 serves as a second rotary element, and the ring gear 10 serves as a third rotary element.

An output shaft 13 of the engine 3 is connected to an input shaft 14 of the power split mechanism 6 connected to the carrier 12 so that output power of the engine 3 is applied to the carrier 12. Optionally, an additional gear unit may be interposed between the input shaft 14 and the carrier 12, and a damper device and a torque converter may be interposed between the output shaft 13 and the input shaft 14.

The sun gear 9 is connected to the first motor 4. In the vehicle Ve shown in FIG. 1, the power split section 7 and the first motor 4 are arranged concentrically with a rotational center axis of the engine 3, and the first motor 4 is situated on an opposite side of the engine 3 across the power split section 7. The transmission section 8 is interposed coaxially between the power split section 7 and the engine 3.

The transmission section 8 is also a single-pinion planetary gear unit comprising: a sun gear 15; a ring gear 16 as an internal gear arranged concentrically around the sun gear 15; plurality of pinion gears 17 interposed between the sun gear 15 and the ring gear 16 while being meshed with both gears 15 and 16; and a carrier 18 supporting the pinion gears 17 in a rotatable manner. Thus, the transmission section 8 is also adapted to perform a differential action among the sun gear 15, the ring gear 16, and the carrier 18. Accordingly, the transmission section 8 serves as a second differential mechanism of the embodiment. In the transmission section 8, the sun gear 15 is connected to the ring gear 10 of the power split section 7, and the ring gear 16 is connected to an output gear 19. In the drive unit 2, accordingly, the ring gear 16 serves as a fourth rotary element, the sun gear 15 serves as a fifth rotary element, the carrier 18 serves as a sixth rotary element, and the output gear 19 serves as an output member.

In order to operate the power split section 7 and the transmission section 8 as a complex planetary gear unit, a first clutch CL1 as a first engagement device is disposed to selectively connect the carrier 18 of the transmission section 8 to the carrier 12 of the power split section 7 connected to the input shaft 14. The first clutch CL1 includes a pair of engagement elements 12a and 12b selectively engaged to each other to transmit the torque. Specifically, the input element 12a is fitted onto the input shaft 14, and the output element 12b is connected to the carrier 18 of the transmission section 8. For example, a wet-type multiple plate clutch or a dog clutch may be adopted as the first clutch CL1. Otherwise, a normally stay clutch may also be adopted as the first clutch CL1. An engagement state of the normally stay clutch is switched upon reception of the command signal, and the normally stay clutch stays in the current engagement state even if the signal transmission thereto is interrupted. Thus, in the drive unit 2 shown in FIG. 1, the power split section 7 is connected to the transmission section 8 to serve as a complex planetary gear unit by engaging the first clutch CL1. In the complex planetary gear unit thus formed, the carrier 12 of the power split section 7 is connected to the carrier 18 of the transmission section 8 to serve as an input element, the sun gear 9 of the power split section 7 serves as a reaction element, and the ring gear 16 of the transmission section 8 serves as an output element. That is, the complex planetary gear unit is configured such that the input shaft 14, the output shaft 4a of the first motor 4, and an after-mentioned driven gear 21 are allowed to rotate in a differential manner.

A second clutch CL2 as a second engagement device is disposed to rotate the rotary elements of the transmission section 8 integrally. For example, a friction clutch, a dog clutch and a normally stay clutch may also be adopted as the second clutch CL2 to selectively connect the carrier 18 to the ring gear 16 or the sun gear 15, or to connect the sun gear 15 to the ring gear 16. In the drive unit 2 shown in FIG. 1, specifically, the second clutch CL2 is engaged to connect the carrier 18 to the ring gear 16 to rotate the rotary elements of the transmission section 8 integrally. The second clutch CL2 includes a pair of engagement elements 18a and 18b selectively engaged to each other to transmit the torque. Specifically, the input element 18a is connected to the carrier 18 of the transmission section 8, and the output element 18b is connected to the ring gear 16 of the transmission section 8.

A counter shaft 20 extends parallel to a common rotational axis of the engine 3, the power split section 7, and the transmission section 8. A driven gear 21 is fitted onto one end of the counter shaft 20 to be meshed with the output gear 19, and a drive gear 22 is fitted onto the other end of the counter shaft 20 to be meshed with a ring gear 24 of a differential gear unit 23 as a final reduction unit. The driven gear 21 is also meshed with a drive gear 26 fitted onto a rotor shaft 25 of the second motor 5 so that power or torque of the second motor 5 is synthesized with power or torque of the output gear 19 at the driven gear 21 to be distributed from the differential gear unit 23 to the front wheels 1R and 1L via each driveshaft 27.

In order to selectively stop a rotation of the engine 3 when operating the first motor 4 to propel the vehicle Ve, a brake B1 as a third engagement device is arranged in the drive unit 2. For example, a frictional engagement device or a dog brake may be adopted as the brake B1, and the brake B1 is fixed to a predetermined stationary member in radially outer side of the output shaft 13 or the input shaft 14. The carrier 12 of the power split section 7 and the carrier 18 of the transmission section 8 are allowed to serve as reaction elements, and the sun gear 9 of the power split section 7 is allowed to serve as an input element by applying the brake B1 to halt the output shaft 13 or the input shaft 14. To this end, the brake B1 may be adapted to stop the rotation of the output shaft 13 or the input shaft 14 not only completely but also incompletely to apply a reaction torque to those shafts. Alternatively, a one-way clutch may be adopted instead of the brake B1 to restrict a reverse rotation of the output shaft 13 or the input shaft 14.

A first power control system 28 is connected to the first motor 4, and a second power control system 29 is connected to the second motor 5. Each of the first power control system 28 and the second power control system 29 includes an inverter and a converter. The first power control system 28 and the second power control system 29 are connected to each other, and also connected individually to a battery 30 as an electric storage device including a lithium ion battery, a capacitor, and a solid-state battery. For example, when the first motor 4 is operated as a generator while establishing a reaction torque, an electric power generated by the first motor 4 may be supplied directly to the second motor 5 without passing through the battery 30.

Characteristics of the lithium ion battery, the capacitor, and the solid-state battery adopted as the battery 30 are different from one another. The battery 30 may also be formed by combining those storage devices arbitrarily according to need.

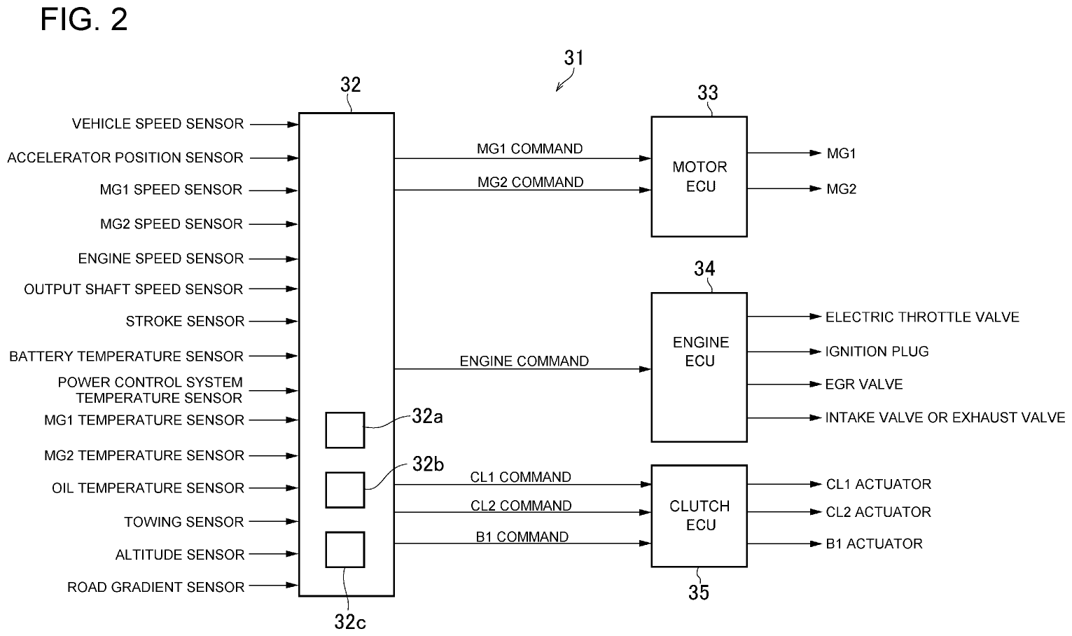

In order to control the first power control system 28, the second power control system 29, the engine 3, the first clutch CL1, the second clutch CL2, the brake B1 and so on, the vehicle Ve is provided with an electronic control unit (to be abbreviated as the “ECU” hereinafter) 31 as a controller. The ECU 31 has a microcomputer as its main constituent, and as shown in FIG. 2, the ECU 31 comprises a main ECU 32, a motor ECU 33, an engine ECU 34 and a clutch ECU 35.

The main ECU 32 is configured to execute a calculation based on incident data transmitted from sensors as well as maps and formulas installed in advance, and transmits a calculation result to the motor ECU 33, the engine ECU 34, and the clutch ECU 35 in the form of command signal. For example, the main ECU 32 receives data about; a vehicle speed; an accelerator position; a speed of the first motor 4; a speed of the second motor 5; a speed of the output shaft 13 of the engine 3; an output speed such as a rotational speed of the counter shaft 20 of the transmission section 8; strokes of pistons (or actuators) of the clutches CL1, CL2, and the brake B1; a temperature of the battery 30; temperatures of the power control systems 28 and 29; a temperature of the first motor 4; a temperature of the second motor 5; a temperature of oil (i.e., ATF) lubricating the power split section 7 and the transmission section 8; a state of charge (to be abbreviated as the “SOC” hereinafter) level of the battery 30; a signal from a towing switch; an altitude above sea level (i.e., an elevation); a road gradient and so on. As shown in FIG. 2, the main ECU 32 comprises: a load determiner 32a that determines a load on the vehicle Ve; a power supplier 32b that sets an upper limit of an output power of the battery 30 to a normal upper limit value during normal propulsion; and a power limiter 32c that restricts the upper limit of the output power of the battery 30 during high load operation, to a restricted upper limit value which is smaller than the normal upper limit value.

Specifically, command signals of output torques and speeds of the first motor 4 and the second motor 5 are transmitted from the main ECU 32 to the motor ECU 33. Likewise, command signals of an output torque and a speed of the engine 3 are transmitted from the main ECU 32 to the engine ECU 34, and command signals of torque transmitting capacities (including “0”) of the clutches CL1, CL2, and the brake B1 are transmitted from the main ECU 32 to the clutch ECU 35.

The motor ECU 33 calculates current values to be applied to the first motor 4 and the second motor 5 based on the data transmitted from the main ECU 32, and transmits calculation results to the motors 4 and 5 in the form of command signals. In the vehicle Ve, an AC motor is adopted as the first motor 4 and the second motor 5 respectively. In order to control the AC motor, the command signals transmitted from the motor ECU 33 include command signals for controlling a frequency of a current generated by the inverter and a voltage value boosted by the converter.

The engine ECU 34 calculates current values and pulse numbers to control opening degrees of an electronic throttle valve, an EGR (Exhaust Gas Restriction) valve, an intake valve, an exhaust valve, and an exhaust valve, and to activate an ignition plug, based on the data transmitted from the main ECU 32. Calculation results are transmitted from the engine ECU 34 to the valves and the plug in the form of command signals. Thus, the engine ECU 34 transmits command signals for controlling a power, an output torque and a speed of the engine 3.

The clutch ECU 35 calculates current values to be supplied to actuators controlling engagement pressures of the clutches CL1, CL2, and the brake B1 based on the data transmitted from the main ECU 32, and transmits calculation results to the actuators of those engagement devices in the form of command signals.

In the vehicle Ve, an operating mode may be selected from a hybrid mode (to be abbreviated as the “HV mode” hereinafter) in which the vehicle Ve is propelled by a drive torque generated by the engine 3, and an electric vehicle mode (to be abbreviated as the “EV mode” hereinafter) in which the vehicle Ve is propelled by drive torques generated by the first motor 4 and the second motor 5 without operating the engine 3. The HV mode may be selected from a Hybrid-Low mode (to be abbreviated as the “HV-Low mode” hereinafter), a Hybrid-High mode (to be abbreviated as the “HV-High mode” hereinafter), and a fixed mode. Specifically, in the HV-Low mode, a rotational speed of the engine 3 (i.e., a rotational speed of the input shaft 14) is increased higher than a rotational speed of the ring gear 16 of the transmission section 8 when a rotational speed of the first motor 4 is reduced to substantially zero. In the HV-High mode, a rotational speed of the engine 3 is reduced lower than a rotational speed of the ring gear 16 of the transmission section 8 when a rotational speed of the first motor 4 is reduced to substantially zero. Further, in the fixed mode, the engine 3 and the ring gear 16 of the transmission section 8 are always rotated at substantially same speeds. Here, it is to be noted that a toque amplification factor in the HV-Low mode is greater than that in the HV-High mode.

The EV mode may be selected from a dual-motor mode in which both of the first motor 4 and the second motor 5 generate drive torques to propel the vehicle Ve, and a single-motor mode (or a disconnecting mode) in which only the second motor 5 generates a drive torque to propel the vehicle Ve. Further, the dual-motor mode may be selected from an Electric Vehicle-Low mode (to be abbreviated as the “EV-Low mode” hereinafter) in which a torque of the first motor 4 is multiplied by a relatively large factor, and an Electric Vehicle-High mode (to be abbreviated as the “EV-High mode” hereinafter) in which a torque of the first motor 4 is multiplied by a factor smaller than that in the EV-Low mode. In the single-motor mode, the vehicle Ve is powered only by the second motor 5 while disengaging both of the first clutch CL1 and the second clutch CL2, or engaging one of the first clutch CL1 and the second clutch CL2.

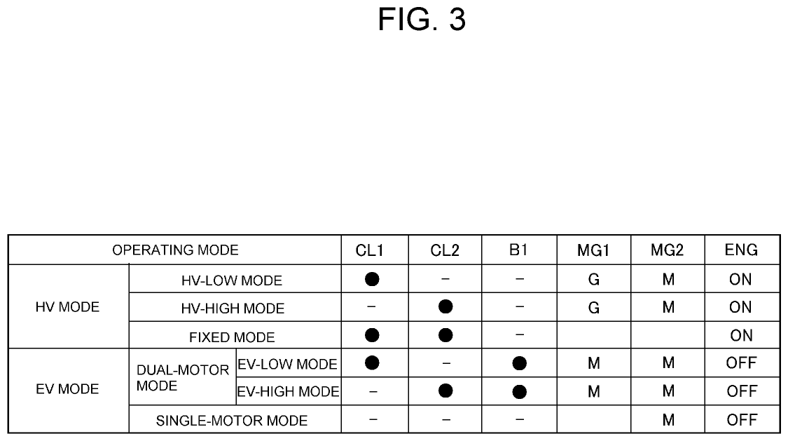

FIG. 3 shows engagement states of the first clutch CL1, the second clutch CL2, and the brake B1, and operating conditions of the first motor 4, the second motor 5, and the engine 3 in each operating mode. In FIG. 3, “●” represents that the engagement device is in engagement, “-” represents that the engagement device is in disengagement, “G” represents that the motor serves mainly as a generator, “M” represents that the motor serves mainly as a motor, blank represents that the motor serves as neither a motor nor a generator or that the motor is not involved in propulsion of the vehicle Ve, “ON” represents that the engine 3 generates a drive torque, and “OFF” represents that the engine 3 does not generate a drive torque.

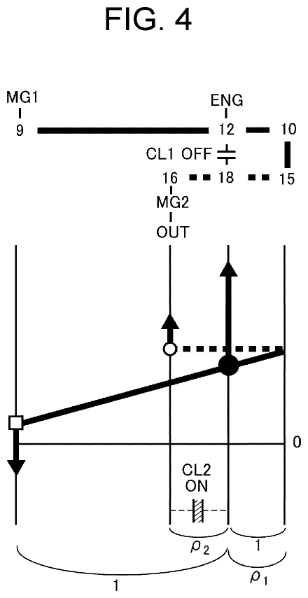

Rotational speeds of the rotary elements of the power split mechanism 6, and directions of torques of the engine 3, the first motor 4, and the second motor 5 in each operating mode are indicated in FIGS. 4 to 9. In the nomographic diagrams shown in FIGS. 4 to 9, the distances among the vertical lines represent a gear ratio of the power split mechanism 6, the vertical distances on the vertical lines from the horizontal base line represent rotational speeds of the rotary members, the orientations of the arrows represent directions of the torques, and the length of the arrows represent magnitude of the torques.

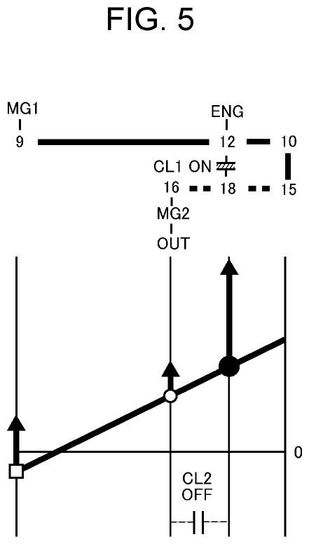

As indicated in FIG. 4, in the HV-High mode, the second clutch CL2 is engaged, and the engine 3 generates a drive torque while establishing a reaction torque by the first motor 4. As indicated in FIG. 5, in the HV-Low mode, the first clutch CL1 is engaged, and the engine 3 generates a drive torque while establishing a reaction torque by the first motor 4. In the HV-High mode and the HV-Low mode, a rotational speed of the first motor 4 is controlled in such a manner as to optimize a total energy efficiency in the drive unit 2 including a fuel efficiency of the engine 3 and a driving efficiency of the first motor 4. Specifically, the total energy efficiency in the drive unit 2 may be calculated by dividing a total energy consumption by a power to rotate the front wheels 1R and 1L. The rotational speed of the first motor 4 may be varied continuously, and the rotational speed of the engine 3 is governed by the rotational speed of the first motor 4 and a speed of the vehicle Ve. That is, the power split mechanism 6 may serve as a continuously variable transmission.

As a result of establishing the reaction torque by the first motor 4, the first motor 4 serves as a generator. In this situation, therefore, a power of the engine 3 is partially translated into an electric energy, and the remaining power of the engine 3 is delivered to the ring gear 16 of the transmission section 8. Specifically, the reaction torque established by the first motor 4 is governed by a split ratio of the torque delivered from the engine 3 to the first motor 4 side through the power split mechanism 6. Such split ratio between the torque delivered from the engine 3 to the first motor 4 side through the power split mechanism 6 and the torque delivered from the engine 3 to the ring gear 16 differs between the HV-Low mode and the HV-High mode.

Given that the torque delivered to the first motor 4 side is “1”, a ratio of the torque applied to the ring gear 16 in the HV-Low mode may be expressed as “1/(ρ1·ρ2)”, and a ratio of the torque applied to the ring gear 16 in the HV-High mode may be expressed as “1/(ρ1)”. In other words, given that the torque of the engine 3 is “1”, a ratio of the torque of the engine 3 delivered to the ring gear 16 in the HV-Low mode may be expressed as “1/(1−(ρ1·ρ2))”, and a ratio of the torque of the engine 3 delivered to the ring gear 16 in the HV-High mode may be expressed as “1/(ρ1+1)”. In the above expressions, “ρ1” is a gear ratio of the power split section 7 (i.e., a ratio between the teeth number of the ring gear 10 and the teeth number of the sun gear 9), and “ρ2” is a gear ratio of the transmission section 8 (i.e., a ratio between the teeth number of the ring gear 16 and the teeth number of the sun gear 15). Specifically, “ρ1” and “ρ2” are individually smaller than “1”. That is, in the HV-Low mode, the ratio of the torque delivered to the ring gear 16 is increased in comparison with that in the HV-High mode.

Here, when the speed of the engine 3 is increased by increasing the torque generated by the engine 3, the output torque of the engine 3 is reduced by a torque required to increase the speed of the engine 3. In the HV mode, the electric power generated by the first motor 4 may be supplied to the second motor 5, and in addition, the electric power accumulated in the electric storage device 32 may also be supplied to the second motor 5 as necessary.

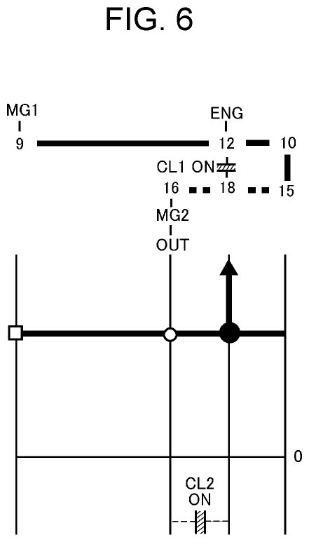

In the fixed mode, as indicated in FIG. 6, both of the first clutch CL1 and the second clutch CL2 are engaged so that all of the rotary elements in the power split mechanism 6 are rotated individually at a same speed. In other words, the output power of the engine 3 will not be translated into an electric energy by the first motor 4 and the second motor 5. For this reason, a power loss associated with such energy conversion will not be caused in the fixed mode and hence power transmission efficiency can be improved.

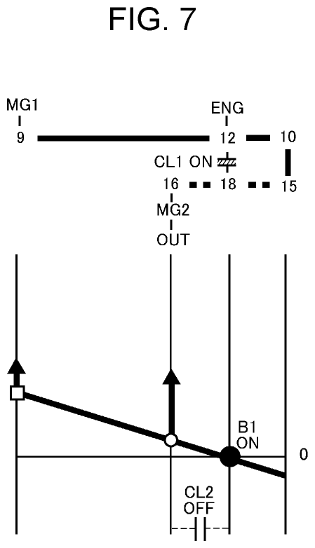

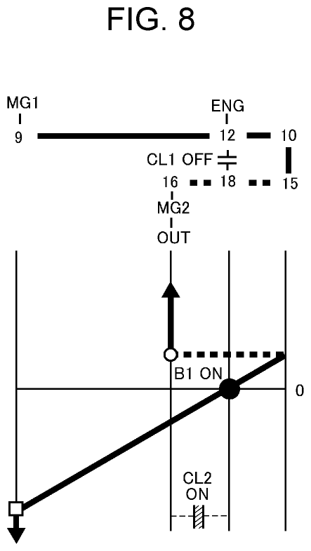

As indicated in FIGS. 7 and 8, in the EV-Low mode and the EV-High mode, the brake B1 is engaged, and the first motor 4 and the second motor 5 generate the drive torques to propel the vehicle Ve. As indicated in FIG. 7, in the EV-Low mode, the vehicle Ve is propelled by the drive torques generated by the first motor 4 and the second motor 5 while engaging the brake B1 and the first clutch CL1. In this case, the brake B1 establishes a reaction torque to restrict a rotation of the output shaft 13 or the carrier 12. In the EV-Low mode, the first motor 4 is rotated in the forward direction while generating torque in a direction to increase a rotational speed. As indicated in FIG. 8, in the EV-High mode, the vehicle Ve is propelled by drive torques generated by the first motor 4 and the second motor 5 while engaging the brake B1 and the second clutch CL2. In this case, the brake B1 also establishes a reaction torque to restrict a rotation of the output shaft 13 or the carrier 12. In the EV-High mode, the first motor 4 is rotated in the opposite direction (i.e., in a reverse direction) to the rotational direction of the engine 3 while generating a torque in a direction to increase a rotational speed.

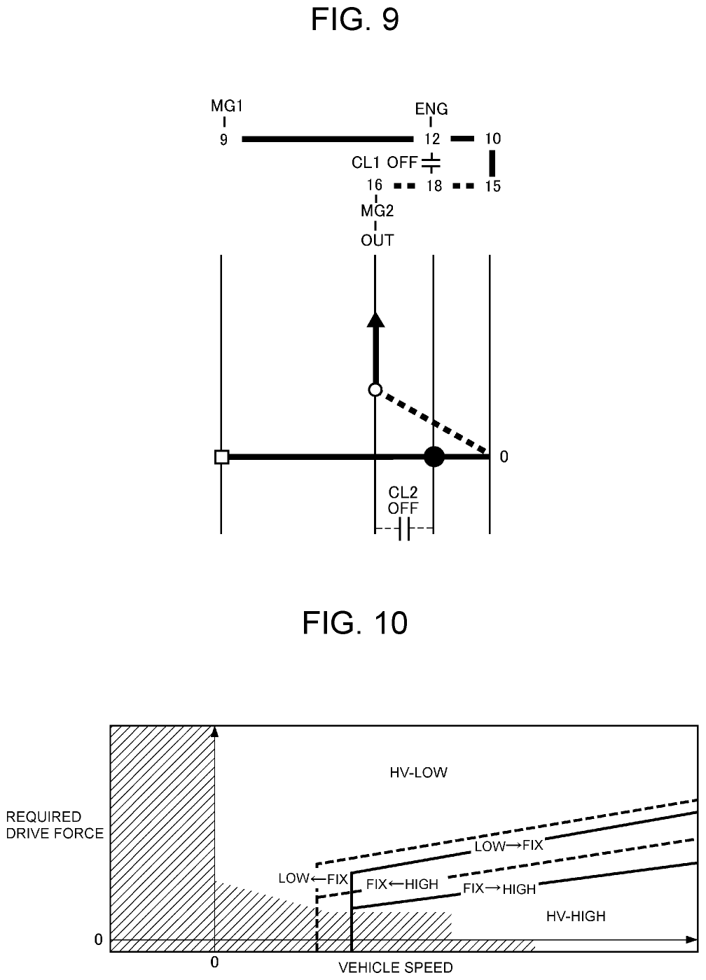

In the EV-Low mode, a ratio of a rotational speed of the ring gear 16 of the transmission section 8 to a rotational speed of the first motor 4 is reduced smaller than that in the EV-High mode. That is, in the EV-Low mode, the rotational speed of the first motor 4 at a predetermined vehicle speed is increased higher than that in the EV-High mode. In other words, a speed reducing ratio in the EV-Low mode is greater than that in the EV-High mode. In the EV-Low mode, therefore, a larger drive force may be generated. Here, in the drive unit 2 shown in FIG. 1, the rotational speed of the ring gear 16 corresponds to a rotational speed of an output member, and the following explanation will be made on the assumption that a gear ratio among each member from the ring gear 16 to the front wheels 1R and 1L is “1” for the sake of convenience. As indicated in FIG. 9, in the single-motor mode, only the second motor 5 generates a drive torque, and both of the first clutch CL1 and the second clutch CL2 are disengaged. In the single-motor mode, therefore, all of the rotary elements of the power split mechanism 6 are stopped. For this reason, the engine 3 and the first motor 4 will not be rotated passively, and hence the power loss can be reduced.

In the vehicle Ve, the operating mode is selected on the basis of an SOC level of the battery 30, a vehicle speed, a required drive force and so on. According to the embodiment, a selection pattern of the operating mode may be selected from a Charge Sustaining mode (to be abbreviated as the “CS mode” hereinafter) in which the operating mode is selected in such a manner as to maintain the SOC level of the battery 30 as far as possible, and a Charge Depleting mode (to be abbreviated as the “CD mode” hereinafter) in which the operating mode is selected in such a manner as to propel the vehicle Ve while consuming the electric power accumulated in the battery 30. Specifically, the CS mode is selected when the SOC level of the battery 30 is relatively low, and the CD mode is selected when the SOC level of the battery 30 is relatively high.

FIG. 10 shows an example of a map for selecting the operating mode during propulsion in the CS mode. In FIG. 10, the vertical axis represents a required drive force, and the horizontal axis represents a vehicle speed. In order to select the operating mode of the vehicle Ve, the vehicle speed may be detected by the vehicle speed sensor, and the required drive force may be estimated based on an accelerator position detected by the accelerator sensor.

In FIG. 10, the hatched region is an area where the single-motor mode is selected, and the hatched region is determined based on specifications of the second motor 5. In the CS mode, the single-motor mode is selected when the vehicle Ve is propelled in a reverse direction irrespective of the required drive force, and when the vehicle Ve is propelled in a forward direction and the required drive force is small (or when decelerating).

During forward propulsion in the CS mode, the HV mode is selected when a large drive force is required. In the HV mode, the drive force may be generated from a low speed range to a high speed range. When the SOC level of the battery 30 falls close to a lower limit level, therefore, the HV mode may be selected even if an operating point governed by the required drive force and the vehicle speed falls within the hatched region.

As described, the HV mode may be selected from the HV-Low mode, the HV-High mode, and the fixed mode. In the CS mode, specifically, the HV-Low mode is selected when the vehicle speed is relatively low or the required drive force is relatively large, the HV-High mode is selected when the vehicle speed is relatively high and the required drive force is relatively small, and the fixed mode is selected when the operating point falls between a region where the HV-Low mode is selected and a region where the HV-High mode is selected.

In the CS mode, the operating mode is shifted from the fixed mode to the HV-Low mode when the operating point is shifted across the “LOW←FIX” line from right to left, or when the operating point is shifted across the “LOW←FIX” line upwardly from the bottom. By contrast, the operating mode is shifted from the HV-Low mode to the fixed mode when the operating point is shifted across the “LOW→FIX” line from left to right, or when the operating point is shifted across the “LOW→FIX” line downwardly from the top. Likewise, the operating mode is shifted from the HV-High mode to the fixed mode when the operating point is shifted across the “FIX←HIGH” line from right to left, or when the operating point is shifted across the “FIX←HIGH” line upwardly from the bottom. By contrast, the operating mode is shifted from the fixed mode to the HV-High mode when the operating point is shifted across the “FIX→HIGH” line from left to right, or when the operating point is shifted across the “FIX→HIGH” line downwardly from the top.

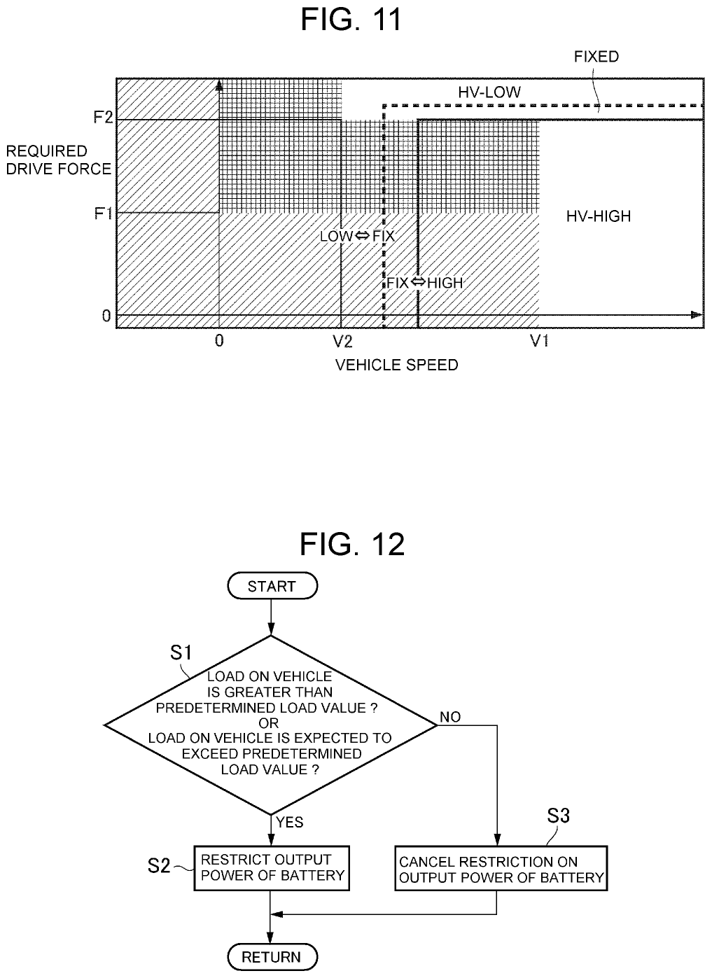

FIG. 11 shows an example of a map for selecting the operating mode during propulsion in the CD mode. In FIG. 11, the vertical axis also represents the required drive force, and the horizontal axis also represents the vehicle speed.

In FIG. 11, the hatched region is also an area where the single-motor mode is selected. In the CD mode, the single-motor mode is also selected when the vehicle Ve is propelled in the reverse direction irrespective of the required drive force, and when the vehicle Ve is propelled in the forward direction and the required drive force is smaller than a first threshold force value F1 (or when decelerating). Such region where the single-motor mode is selected is determined based on specifications of the second motor 5 and so on.

During forward propulsion in the CD mode, the dual-motor mode is selected when the drive force larger than the first threshold force value F1 is required. In this case, the HV mode is selected when the vehicle speed is higher than a first threshold speed V1, or when the vehicle speed is higher than a second threshold speed V2 and the required drive force is greater than a second threshold force value F2. As described, in the HV mode, the drive force may be generated from the low speed range to the high speed range. When the SOC level of the battery 30 falls close to the lower limit level, therefore, the HV mode may be selected even if the operating point falls within the regions where the single-motor mode and the dual-motor mode are selected.

In the CD mode, the HV-Low mode is also selected when the vehicle speed is relatively low and the required drive force is relatively large, the HV-High mode is also selected when the vehicle speed is relatively high and the required drive force is relatively small, and the fixed mode is also selected when the operating point falls between the region where the HV-Low mode is selected and the region where the HV-High mode is selected.

In the CD mode, specifically, the operating mode is shifted between the fixed mode and the HV-Low mode when the operating point is shifted across the “LOW↔FIX” line. Likewise, the operating mode is shifted between the HV-High mode and the fixed mode when the operating point is shifted across the “FIX↔HIGH” line.

In the maps shown in FIGS. 10 and 11, the regions of each of the operating mode and the lines defining the regions may be altered depending on temperatures of the members of the drive unit 2, the battery 30, the power control systems 28 and 29, and an SOC level of the battery 30.

As described, the operating mode of the vehicle Ve is shifted among the above-mentioned modes based on a required drive force governed by a position of the accelerator pedal. For example, when the vehicle Ve is propelled under high load conditions, the HV mode is selected to propel the vehicle Ve not only by the drive torque generated by the engine 3 but also by the drive torque (i.e., the assist torque) generated by the second motor 5. In this situation, if an SOC level of the battery 30 falls to a lower limit level, electricity may no longer be supplied from the battery 30 to the second motor 5. Consequently, the drive torque of the second motor 5 will disappear suddenly, and a speed of the vehicle Ve will no longer be able to be increased. For example, if the vehicle Ve travels on a flat road and hence the load on the vehicle Ve is light, the battery 30 may be charged by an excess power of the engine 3, or by electricity regenerated by the first motor 4 or the second motor 5. However, if the vehicle Ve is propelled under high load continuously or repeatedly, the battery 30 is subjected to a high load continuously or repeatedly, and as a result, the SOC level of the battery 30 will fall and the assist torque generated by the second motor 5 will disappear. In this case, the drive force to propel the vehicle Ve and the speed of the vehicle Ve will be reduced suddenly even if a position of the accelerator pedal is maintained. In order to avoid such sudden reduction in the drive force and the vehicle speed, according to the exemplary embodiment of the present disclosure, the control system executes a routine shown in FIG. 12.

Specifically, the routine shown in FIG. 12 is configured to restrict an upper limit of the output power of the battery 30 upon satisfaction of a predetermined condition, compared to the upper limit in a normal condition. The routine shown in FIG. 12 is executed repeatedly at predetermined time intervals. At step S1, it is determined whether a load on the vehicle Ve is equal to or greater than a predetermined load value, or whether the load on the vehicle Ve is expected to be increased to the predetermined load value or greater.

For example, such determination at step S1 may be made based on the following facts: that a required drive force to propel the vehicle Ve at a predetermined speed is equal to or greater than a threshold value (or range); that the vehicle Ve tows e.g., a mobile home and hence a towing switch is on; that the vehicle Ve continuously climbs a hill whose gradient is equal to or steeper than a threshold degree for a threshold distance or longer; that an altitude above sea level (i.e., an elevation) of a road on which the vehicle Ve travels is equal to or higher than a threshold level; or that a total weight of freight is equal to or heavier than a threshold weight. That is, the answer of step S1 will be YES if a required drive force to propel the vehicle Ve at a predetermined speed is greater than the threshold value, if the vehicle Ve tows an object so that the towing switch is on, if the vehicle Ve climbs a hill whose gradient is steeper than the predetermined degree for a distance longer than the threshold distance, if an altitude above sea level of a road on which the vehicle Ve travels is higher than the threshold level, or if a total weight of freight on the vehicle Ve is heavier than the threshold weight.

Specifically, the required drive force may be obtained based on a position of the accelerator pedal, and the threshold value of the required drive force at a predetermined speed is set to a value at which a current speed of the vehicle Ve can be maintained. For example, the load on the vehicle Ve may also be determined based on an air density or an air intake, instead of the altitude above sea level. The above-mentioned threshold values of e.g., the required drive force may be reduced with a reduction in the SOC level of the battery 30.

In addition, even if the vehicle Ve does not currently travels on a road equal to or higher than the threshold level but the altitude above sea level of the road is predicted to be or exceed the threshold level, the answer of step S1 will be YES. Likewise, even if a road gradient of the hill on which the vehicle Ve travels is currently milder than the threshold degree but predicted to be equal to or steeper than the threshold degree, and a distance of the hill is predicted to reach or exceed the threshold distance, the answer of step S1 will also be YES. Similarly, even if the vehicle Ve does not currently tow an object but has a plan to tow an object on the way, the answer of step S1 will also be YES. Further, even if a total weight of freight on the vehicle Ve is currently not heavier than the threshold weight but has a plan to carry additional freight which increases the toral weight of the freight to the threshold weight or heavier, the answer of step S1 will also be YES. Those predictions may be made based on a planned route created by a navigation system or a GPS signal transmitted to the navigation system. Thus, at step S1, it is determined whether the load on the vehicle Ve is currently equal to or greater than the predetermined load value, or whether the load on the vehicle Ve is predicted to reach or exceed the predetermined load value.

If the load on the vehicle Ve is greater than the predetermined load value, or if the load on the vehicle Ve is expected to exceed the predetermined load value so that the answer of step S1 is YES, the routine progresses to step S2 to restrict the upper limit of the output power of the battery 30 to be smaller than the normal upper limit value. Consequently, the electric power supplied from the battery 30 to the second motor 5 is restricted compared to a case of propelling the vehicle Ve under low load conditions.

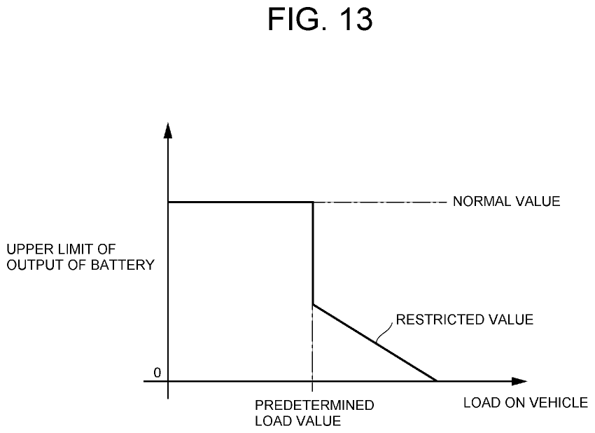

Turning to FIG. 13, there is shown one example of a map determining the upper limit of output power of the battery 30 under the high load conditions and under the low load conditions. As can be seen from FIG. 13, the upper limit of output power of the battery 30 is reduced from the normal upper limit value when the load on the vehicle Ve reaches the predetermined load value, and further reduced gradually with an increase in the load from the predetermined load value. Specifically, the upper limit of output power of the battery 30 under the low load conditions (i.e., the normal upper limit value) is set to a maximum output of the battery 30 governed by specifications of the battery 30, and may be altered in accordance with an SOC level and a temperature thereof. As described, the upper limit of output power of the battery 30 is reduced to a restricted upper limit value when the load on the vehicle Ve reaches the predetermined load value. Then, the upper limit of output power of the battery 30 is further reduced gradually with an increase in the weight of the object towed by the vehicle Ve, the total weight of the freight on the vehicle Ve, the road gradient of the hill on which the vehicle Ve travels, the distance of the hill, or the altitude above sea level of the road on which the vehicle Ve travels.

By contrast, if the load on the vehicle Ve is less than the predetermined load value, or if the load on the vehicle Ve is not expected to reach the predetermined load value so that the answer of step S1 is NO, the routine progresses to step S3 to cancel the restriction on the upper limit of the output power of the battery 30 which has been set in the previous routine. Consequently, the upper limit of the output power of the battery 30 is set to the normal upper limit value shown in FIG. 13. In this case, if the upper limit of the output power of the battery 30 had not been restricted in the previous routine, the routine skips step S3 and returns.

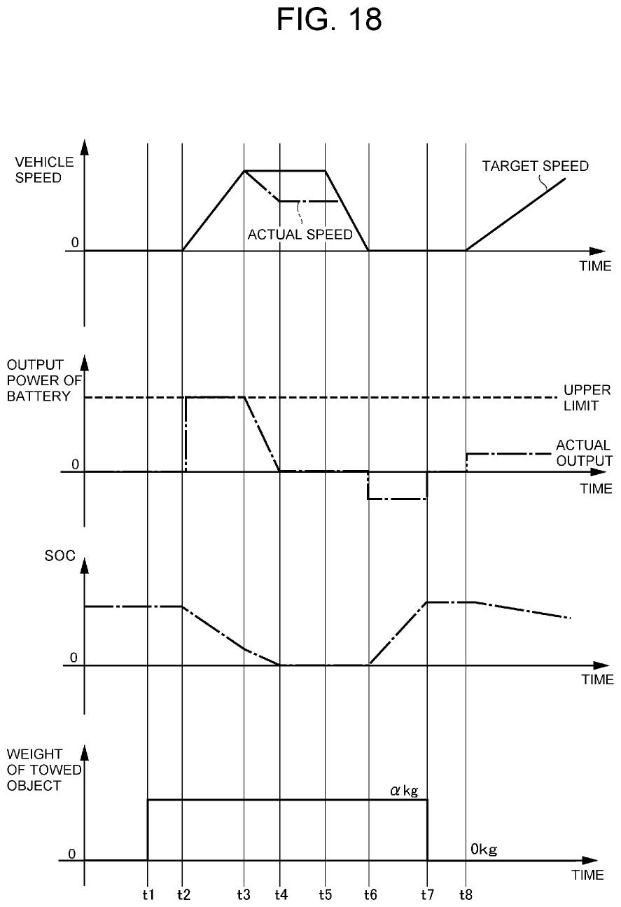

Turing to FIG. 18, there are shown temporal changes in the conditions of the vehicle Ve according to the comparative example, in which the vehicle Ve travels while towing an object but without restricting the upper limit of the output power of the battery 30.

At point t1, an object whose weight is a kg is connected to the vehicle Ve, and the vehicle Ve is launched. As a result, a speed of the vehicle increases from point t2. In this situation, since a load on the vehicle Ve is high, the vehicle Ve is propelled not only by a torque of the engine 3 but also by a torque of the second motor 5. Specifically, an output power of the battery 30 is increased at point t2, and the output power of the battery 30 is maintained to the upper limit value until point t3. In this situation, therefore, an SOC level of the battery 30 falls from point t2.

Then, the vehicle Ve starts cruising from point t3 at a constant speed. In this situation, since the SOC level of the battery 30 is falling toward a lower limit level, the output power of the battery 30 is reduced and an electric power supply to the second motor 5 becomes insufficient. Consequently, the drive torque generated by the second motor 5 to propel the vehicle Ve becomes insufficient, and the actual speed of the vehicle Ve drops suddenly and significantly from point t3. In this situation, a position of the accelerator pedal is maintained during the period from point t3 to t5 so as to propel the vehicle Ve at a constant speed, however, the speed of the vehicle drops against the driver's will.

Then, the vehicle Ve is decelerated from point t5, and stops at point t6. In this situation, the first motor 4 is operated as a generator by an excess power of the engine 3 from point t6. Consequently, the battery 30 is charged with electric power regenerated by the first motor 4 from point t6 so that the SOC level of the battery 30 is raised from 0%. Thereafter, the object is disconnected from the vehicle Ve at point t7, and the accelerator pedal is depressed again at point t8 to launch the vehicle Ve.

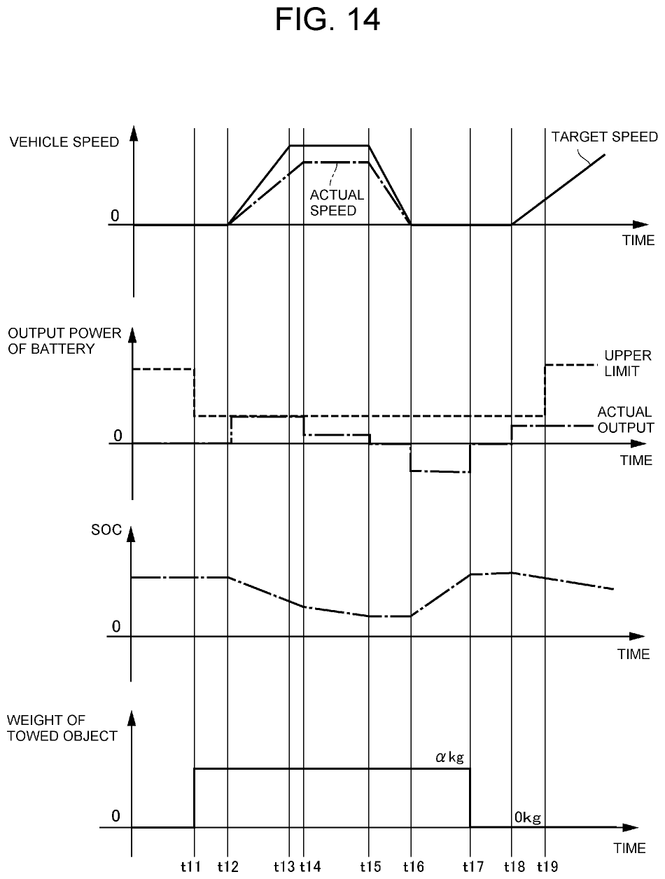

Next, temporal changes in the conditions of the vehicle Ve during execution of the routine shown in FIG. 12 will be explained with reference to FIG. 14. At point t11, an object whose weight is α kg is connected to the vehicle Ve, and consequently a load on the vehicle Ve exceeds the predetermined load value. According to the exemplary embodiment of the present disclosure, the upper limit of the output power of the battery 30 is reduced from point t11 to restrict the output power of the battery 30. In this situation, the accelerator pedal is depressed to launch the vehicle Ve, and a speed of the vehicle increases from point t12. Specifically, since vehicle Ve travels under high load, the vehicle Ve is propelled not only by a torque of the engine 3 but also by a torque of the second motor 5. In this situation, therefore, the output power of the battery 30 is increased to the restricted upper limit value at point t12, and maintained thereto until point t14. Consequently, an SOC level of the battery 30 falls from point t12.

Then, the vehicle Ve starts cruising from point t14 at a constant speed. In this situation, according to the exemplary embodiment of the present disclosure, the upper limit of output power of the battery 30 has been reduced from point t11 at which the load on the vehicle Ve exceeded the predetermined load value. For this reason, the SOC level of the battery 30 does not fall to 0% and hence the electric power is still possible to be supplied from the battery 30 to the second motor 5. According to the exemplary embodiment of the present disclosure, therefore, the drive torque of the second motor 5 may be maintained to prevent sudden reduction in the speed of the vehicle Ve. Thus, the speed of the vehicle Ve may be maintained even after the load on the vehicle Ve is increased.

Then, the vehicle Ve is decelerated from point t15, and stopped at point t16. In this situation, the first motor 4 is operated as a generator by an excess power of the engine 3 from point t16 so that the battery 30 is charged with the electric power regenerated by the first motor 4 from point t16. The object is disconnected from the vehicle Ve at point t17, and the accelerator pedal is depressed again at point t18 to launch the vehicle Ve. Thereafter, the restriction on the upper limit of the output power of the battery 30 is canceled at point t19, and consequently the upper limit of the output power of the battery 30 is set to the normal upper limit value. Here, it is to be noted that the restriction on the upper limit of the output power of the battery 30 may be canceled anytime after disconnecting the object from the vehicle Ve at point t17.

Next, here will be explained another example of a routine executed by the control system according to the exemplary embodiment of the present disclosure. As described, according to the exemplary embodiment of the present disclosure, the upper limit of the output power of the battery 30 is reduced to restrict power supply to the second motor 5 during the high load operation, and consequently the output power of the second motor 5 is restricted. Nonetheless, it is preferable to ensure sufficient power to propel the vehicle Ve by the engine 3 during the high load operation. In order to ensure sufficient power to propel the vehicle Ve during the high load operation, according to another example of the present disclosure, the operating mode in which a higher power can be generated by the engine 3 is selected from the HV-Low mode and the HV-High mode when restricting the upper limit of the output power of the battery 30.

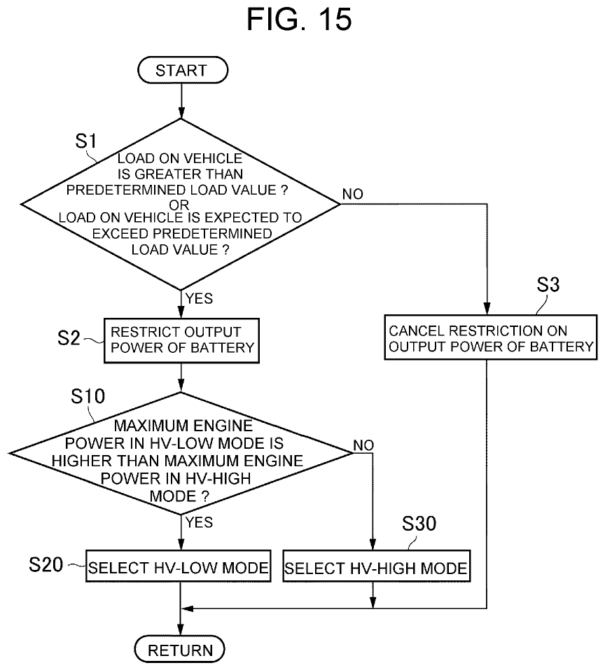

Turning to FIG. 15, there is shown another example of the routine executed by the control system according to the exemplary embodiment of the present disclosure. In the following descriptions, explanations for the steps in common with those of the routine shown in FIG. 12 will be simplified.

At step S1, it is determined whether a load on the vehicle Ve is equal to or greater than the predetermined load value, or whether the load on the vehicle Ve is expected to be increased to the predetermined load value or greater. If the load on the vehicle Ve is greater than the predetermined load value, or if the load on the vehicle Ve is expected to exceed the predetermined load value so that the answer of step S1 is YES, the routine progresses to step S2 to restrict the upper limit of the output power of the battery 30 to be smaller than the normal upper limit value. Consequently, the electric power supplied from the battery 30 to the second motor 5 is restricted to prevent sudden reduction in a speed of the vehicle Ve and sudden drop in a drive force to propel the vehicle Ve.

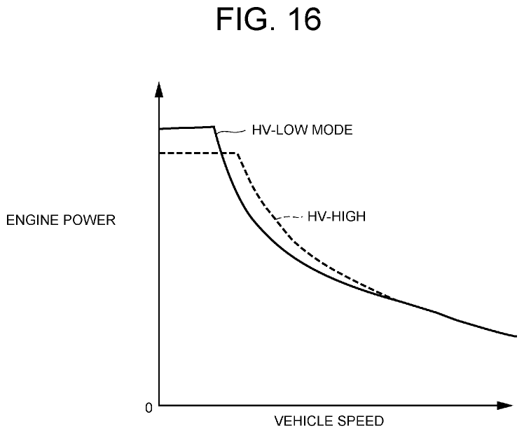

Then, the routine progresses to step S10 to select the operating mode in which a higher power can be generated by the engine 3 from the HV-Low mode and the HV-High mode. In other words, at step S10, it is determined whether an upper limit power (i.e., a maximum output power) of the engine 3 in the HV-Low mode is higher than a maximum output power of the engine 3 in the HV-High mode. In this situation, the output power of the battery 30 is restricted and hence it is necessary to propel the vehicle Ve by the output power of the engine 3. To this end, it is preferable to select the operating mode in which a higher power can be generated by the engine 3. Specifically, the maximum output power of the engine 3 is governed by an upper limit torque and an upper limit speed of the engine 3. That is, the higher power can be generated by the engine 3 in the operating mode in which an upper limit torque of the engine 3 is larger or an upper limit speed of the engine 3 is higher. Specifically, the upper limit speed of the engine 3 is governed by a maximum endurance speed of the pinion gears 11 of the power split section 7, an upper limit speed of the first motor 4 and so on. On the other hand, the upper limit torque of the engine 3 is governed by an upper limit speed of the engine 3, a gear ratio of the power split mechanism 6 and so on. Generally, the upper limit power (i.e., the maximum output power) of the engine 3 in each of the HV-Low mode and the HV-High mode is changed in accordance with a speed of the vehicle Ve. Turning to FIG. 16, there is shown a map determining the maximum output power of the engine 3 in each of the HV-Low mode and the HV-High mode with respect to a speed of the vehicle Ve. As can be seen from FIG. 16, in a low-speed range, the maximum output power of the engine 3 is higher in the HV-Low mode. By contrast, in a speed range higher than the low-speed range, the maximum output power of the engine 3 is higher in the HV-High mode. Accordingly, at step S10, the operating mode is selected from the HV-Low mode and the HV-High mode in accordance with a speed of the vehicle Ve with reference to the map shown in FIG. 16.

If the maximum output power of the engine 3 in the HV-Low mode is higher than the maximum output power of the engine 3 in the HV-High mode so that the answer of step S10 is YES, the routine progresses to step S20 to propel the vehicle Ve in the HV-Low mode by engaging the first clutch CL1. By contrast, if the maximum output power of the engine 3 in the HV-High mode is higher than the maximum output power of the engine 3 in the HV-Low mode so that the answer of step S10 is NO, the routine progresses to step S30 to propel the vehicle Ve in the HV-High mode by engaging the second clutch CL2.

Whereas, if the load on the vehicle Ve is less than the predetermined load value, or if the load on the vehicle Ve is not expected to reach the predetermined load value so that the answer of step S1 is NO, the routine progresses to step S3 to cancel the restriction on the upper limit of the output power of the battery 30 which has been set in the previous routine. In this case, if the upper limit of the output power of the battery 30 had not been restricted in the previous routine, the routine skips step S3 and returns.

Thus, according to the exemplary embodiment of the present disclosure, the upper limit of the output power of the battery 30 is restricted when the load on the vehicle Ve is equal to or heavier than the predetermined load value or expected to reach or exceed the predetermined load value. For example, the upper limit of the output power of the battery 30 is restricted when the vehicle Ve tows an object such as a mobile home, or an altitude above sea level of a road on which the vehicle Ve travels is higher than the threshold level. According to the exemplary embodiment of the present disclosure, therefore, the battery 30 can be prevented from being out of charge so that the drive torque of the second motor 5 can be maintained even if the load on the vehicle Ve is higher than the predetermined load value. For this reason, it is possible to prevent sudden reduction in a speed of the vehicle Ve and sudden drop in a drive force to propel the vehicle Ve during high load operation. In addition, the driver can be prevented from being upset and disturbed by such sudden reduction in a speed of the vehicle Ve and sudden drop in a drive force to propel the vehicle Ve.

In addition, when the upper limit of the output power of the battery 30 is restricted, the operating mode in which a higher power can be generated by the engine 3 is selected from the HV-Low mode and the HV-High mode. According to the exemplary embodiment of the present disclosure, therefore, the drive force to propel the vehicle Ve can be ensured even if the output power of the battery 30 is restricted during high load operation.

Although the above exemplary embodiments of the present disclosure have been described, it will be understood by those skilled in the art that the present disclosure should not be limited to the described exemplary embodiments, and various changes and modifications can be made within the scope of the present disclosure. For example, the control system according to the exemplary embodiment of the present disclosure may also be applied to a vehicle having a different structure.

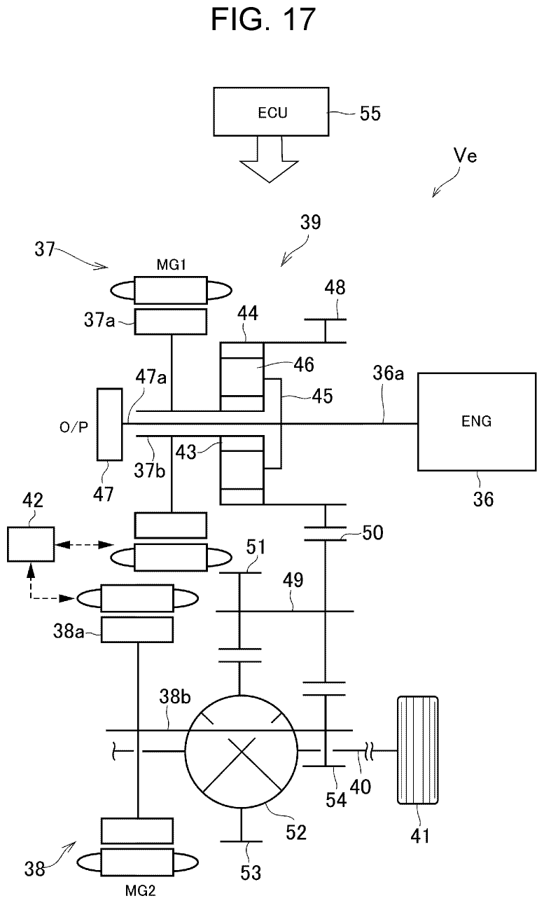

Referring now to FIG. 17, there is shown another example of the vehicle Ve to which the control system according to the exemplary embodiment of the present disclosure is applied. A prime mover of the vehicle Ve comprises an engine (referred to as ENG in FIG. 17) 36, a first motor (referred to as MG1 in FIG. 17) 37, and a second motor (referred to as MG2 in FIG. 17) 38. In the vehicle Ve, an output power of the engine 36 is distributed to the first motor 37 and a driveshaft 40 through a power split mechanism 39. An electric power generated by the first motor 37 may be supplied to the second motor 38 to generate torque, and a drive force generated by the second motor 38 may be delivered to drive wheels 41 through the driveshafts 40.

Each of the first motor 37 and the second motor 38 is a motor-generator that is operated not only as a motor to generate torque by applying electric power thereto, but also as a generator to generate electric power by applying torque thereto. For example, a permanent magnet synchronous motor and an induction motor may be used individually as the first motor 37 and the second motor 38. The first motor 37 and the second motor 38 are electrically connected to a battery 42 and a capacitor through an inverter (neither of which are shown) so that electric power may be supplied to the first motor 37 and the second motor 38 from the battery 42. The battery 42 may also be charged with electric powers generated by the first motor 37 and the second motor 38.

The power split mechanism 39 as a differential mechanism is disposed between the engine 36 and the first motor 37. According to the exemplary embodiment of the present disclosure, a single-pinion planetary gear unit is adopted as the power split mechanism 39 to transmit torque between: the engine 36 and the first motor 37; and the drive wheels 41. The power split mechanism 39 comprises a sun gear 43, a ring gear 44 arranged concentrically with the sun gear 43, a plurality of pinion gears 46 interposed between the sun gear 43 and the ring gear 44, and a carrier 45 supporting the pinion gears 46 in a rotatable and revolvable manner.

The power split mechanism 39 is arranged coaxially with the engine 36 and the first motor 37. Specifically, an output shaft 36a of the engine 36 is connected to the carrier 45 of the power split mechanism 39 so that the output shaft 36a serves as an input shaft of the power split mechanism 39. In order to cool and lubricate the power split mechanism 39, and to reduce fevers of the first motor 37 and the second motor 38, an oil pump 47 is arranged on an opposite side of the engine 36 across the power split mechanism 39. Specifically, the carrier 45 of the power split mechanism 39 is also connected to a rotary shaft 47a of the oil pump 47 so that the oil pump 47 is driven by the engine 36 to generate hydraulic pressure.

The first motor 37 is disposed between the oil pump 47 and the power split mechanism 39, and in the first motor 37, a hollow rotor shaft 37b that is rotated integrally with a rotor 37a is connected to the sun gear 43 of the power split mechanism 39. The rotary shaft 47a of the oil pump 47 penetrates through the rotor shaft 37b and the sun gear 43 to be connected to the output shaft 36a of the engine 36 through the carrier 45.

A first drive gear 48 as an external gear is integrally formed around the ring gear 44 of the power split mechanism 39 to serve as an output member, and a countershaft 49 is arranged in parallel with a common rotational axis of the power split mechanism 39 and the first motor 37. A counter driven gear 50 diametrically larger than the first drive gear 48 is fitted onto one end of the countershaft 49 (i.e., right side in FIG. 17) to be rotated integrally therewith while being meshed with the first drive gear 48 so that torque transmitted from the first drive gear 48 is multiplied. A counter drive gear 51 is fitted onto the other end of the countershaft 49 (i.e., left side in FIG. 17) in such a manner as to be rotated integrally therewith while being meshed with a differential ring gear 53 of a deferential gear unit 52 as a final reduction. Thus, the ring gear 44 of the power split mechanism 39 is connected to the driveshaft 40 and the drive wheels 41 through an output gear train including the first drive gear 48, the countershaft 49, the counter driven gear 50, the counter drive gear 51, and the differential ring gear 53.

In the vehicle Ve, an output torque of the second motor 38 can be added to the torque delivered from the power split mechanism 39 to the drive wheels 41 through the driveshaft 40. To this end, a rotor 38a of the second motor 38 is connected to a rotor shaft 38b extending in parallel with the countershaft 49 to rotate integrally therewith, and a second drive gear 54 is fitted onto a leading end of the rotor shaft 38b to be rotated integrally therewith while being meshed with the counter driven gear 50. Thus, the ring gear 44 of the power split mechanism 39 is connected to the second motor 38 through the differential ring gear 53 and the second drive gear 54. That is, the ring gear 44 and the second motor 38 are individually connected to the drive wheels 41 through the differential ring gear 53 and the driveshaft 40.

An operating mode of the vehicle Ve may also be selected from the HV mode in which the vehicle Ve is powered by the engine 36, and the EV mode in which the vehicle Ve is powered by the first motor 37 and the second motor 38 while supplying electric power to the motors 37 and 38 from the battery 42. The operating mode of the vehicle Ve shown in FIG. 17 is shifted by an electronic control unit (to be abbreviated as the “ECU” hereinafter) 55 also serving as the controller of the exemplary embodiment of the present disclosure. The ECU 55 is electrically connected to the engine 36, the first motor 37, the second motor 38, the battery 42 and so on. The ECU 55 comprises a microcomputer as its main constituent configured to carry out a calculation based on incident data, stored data and stored programs, and transmit a calculation result in the form of command signal. For example, a vehicle speed, a wheel speed, a position of an accelerator pedal, an SOC level of the battery 42 and so on are sent to the ECU 55, and maps determining e.g., the operating mode are installed in the ECU 55. Specifically, the ECU 55 transmits command signals for starting and stopping the engine 36, torque command signals for operating the engine 36, the first motor 37, and the second motor 38 and so on.

The ECU 55 is also configured to execute the routine shown in FIG. 12. Specifically, the ECU 55 also restricts an upper limit of an output power of the battery 42 if a load on the vehicle Ve is equal to or greater than or expected to reach or exceed the predetermined load value. For this reason, a speed of the vehicle Ve shown in FIG. 17 will not be reduced suddenly and undesirably due to reduction in the SOC level of the battery 42 even during the high load operation.

In order to prevent the above-explained sudden reduction in the speed of the vehicle Ve during the high load operation, the output power of the battery 30 or 42 may be reduced to zero. In this case, the electricity accumulated in the battery 30 or 42 will not be consumed to operate the second motor 5 or 38 so that the battery 30 or 42 may be prevented certainly from being out of charge.

What is claimed is:

1. A control system for a hybrid vehicle, comprising:
an engine that serves as a main prime mover to generate a drive torque to propel the hybrid vehicle;
a motor that generates an assist torque added to the drive torque generated by the engine; and
an electric storage device that supplies an electric power to the motor to generate the assist torque by the motor, when a required drive force to propel the hybrid vehicle is equal to or greater than a threshold force,
wherein the control system comprises a controller that controls an output torque of the motor, and
the controller comprises:
a determiner that is configured to determine a satisfaction of a predetermined condition; and
a power limiter that is configured to restrict an upper limit of an output power of the electric storage device supplied to the motor upon satisfaction of the predetermined condition, to a restricted upper limit value that is smaller than a normal upper limit value set in a case that the predetermined condition is not satisfied.

2. The control system for the hybrid vehicle as claimed in claim 1,
wherein the determiner is further configured to predict a satisfaction of the predetermined condition, and
the power limiter is further configured to restrict the upper limit of the output power of the electric storage device to the restricted upper limit value when the determiner predicts a satisfaction of the predetermined condition.

3. The control system for the hybrid vehicle as claimed in claim 1, wherein the predetermined condition includes a fact that the required drive force to propel the hybrid vehicle at a predetermined speed is equal to or greater than a threshold value.

4. The control system for the hybrid vehicle as claimed in claim 1, wherein the predetermined condition includes at least one of:
a fact that the hybrid vehicle tows an object;
a fact that the hybrid vehicle continuously climbs a hill whose gradient is equal to or steeper than a threshold degree for a threshold distance or longer;
a fact that an altitude above sea level of a road on which the hybrid vehicle travels is equal to or higher than a threshold level; and
a fact that a total weight of freight on the hybrid vehicle is equal to or heavier than a threshold weight.

5. The control system for the hybrid vehicle as claimed in claim 4, wherein the upper limit of the output power of the electric storage device is reduced with an increase in:
the distance of the hill whose gradient is equal to the threshold degree or steeper;
the altitude above sea level of the road; or
the total weight of the freight on the hybrid vehicle.

6. The control system for the hybrid vehicle as claimed in claim 1, wherein the predetermined condition includes a condition that is changed in accordance with a state of charge level of the electric storage device.

7. The control system for the hybrid vehicle as claimed in claim 1,
wherein the motor includes a first motor and a second motor, the hybrid vehicle further comprises:
a first differential mechanism that performs a differential action among a first rotary element that is connected to the engine, a second rotary element that is connected to the first motor, and a third rotary element;
a second differential mechanism that performs a differential action among a fourth rotary element that is connected to the second motor and a pair of drive wheels, a fifth rotary element that is connected to the third rotary element, and a sixth rotary element;
a first engagement device that selectively connects the first rotary element to the sixth rotary element; and
a second engagement device that selectively connects any two of the fourth rotary element, the fifth rotary element, and the sixth rotary element, and
an operating mode of the hybrid vehicle includes:
a first hybrid mode that is established by engaging the first engagement device while disengaging the second engagement device; and
a second hybrid mode that is established by engaging the second engagement device while disengaging the first engagement device.

8. The control system for the hybrid vehicle as claimed in claim 7, wherein the controller is configured to select the operating mode in which a maximum output power of the engine is higher from the first hybrid mode and the second hybrid mode, upon satisfaction of the predetermined condition.

9. The control system for the hybrid vehicle as claimed in claim 8, wherein the maximum output power of the engine is governed by an upper limit torque of the engine and an upper limit speed of the engine governed by characteristics of constitutional members of the differential mechanisms.

10. The control system for the hybrid vehicle as claimed in claim 1, wherein the controller is configured to cancel the restriction on the upper limit of the output power of the electric storage device when the predetermined condition is no longer satisfied.
